(19) United States
(12) Patent Application Publication
(10) Pub. No.: US 2022/0319105 A1
(43) Pub. Date: Oct. 6, 2022

(54) IMAGE DISPLAY APPARATUS, IMAGE DISPLAY SYSTEM, AND IMAGE DISPLAY METHOD

(71) Applicant: Sony Interactive Entertainment Inc., Tokyo (JP)

(72) Inventors: Yoshinori Ohashi, Tokyo (JP); Kazuyuki Arimatsu, Tokyo (JP)

(73) Assignee: Sony Interactive Entertainment Inc., Tokyo (JP)

(21) Appl. No.: 17/596,043

(22) PCT Filed: Jul. 3, 2020
(86) PCT No.: PCT/JP2020/026115

§ 371 Date: Dec. 2, 2021

(30) Foreign Application Priority Data
Jul. 10, 2019 (JP) 2019-128665
Jul. 10, 2019 (JP) 2019-128666

(51) Int. Cl. G06T 15/20; G06T 15/04; G06T 5/00; G06T 15/00; G06F 3/01; A63F 13/52

(52) U.S. Cl. CPC G06T 15/205; G06T 15/04; G06T 5/006; G06T 15/005; G06F 3/012; A63F 13/52

(57) ABSTRACT

A reprojection unit executes reprojection processing for converting an image including depth value information to align with a viewpoint position or a line of sight direction according to a plurality of different depth values, and generates a composite image by compositing a plurality of images subjected to the reprojection processing according to the plurality of different depth values. A distortion processing unit executes distortion processing for transforming the composite image in alignment with distortion arising in a display optical system.

### TECHNICAL FIELD

This invention relates to an image display apparatus, an image display system, and an image display method.

### BACKGROUND ART

Some games are played by mounting a head-mounted display connected to a game device to a head of a user and operating a controller or the like while the user views a screen displayed by the head-mounted display. When the head-mounted display is mounted, because the user does not look at anything apart from a video displayed by the head-mounted display, there is an effect that a sense of immersion into the video world increases and the ability of the game to entertain increases further. In addition, when the head-mounted display is caused to display a VR (Virtual Reality) video and the user who wears the head-mounted display rotates his or her head, and when a virtual space for the entire circumference of 360 degrees that can be looked over is made to be displayed, the sense of immersion into the video improves further, and the operability of an application which is a game or the like also improves.

In a case where a head-mounted display is caused to have a head tracking function in this manner and a virtual reality video is generated while a viewpoint and a line of sight direction interlocked with movement of the user's head are changed, there is a delay between generation of the virtual reality video and display of this video. Therefore, there are cases where deviation occurs between the orientation of the head of the user set as a premise for the time of video generation and the orientation of the head of the user when the video is displayed by the head-mounted display, and the user suffers from a sense of being intoxicated (referred to as VR sickness or the like).

Accordingly, measures are taken to perform processing referred to as a “time warp” or “reprojection” which corrects a rendered image in alignment with the latest position and orientation of the head-mounted display, and make the user sense less deviation.

### Summary Technical Problems

In conventional reprojection processing, because the entirety of an image is converted assuming that the depth of the image is uniform overall even in a region where the depth differs, there are cases where discomfort is felt with a reprojected image. In particular, in a case of an image that includes a region where the depth differs greatly, in order to avoid discomfort due to reprojection, there is a limit on interpolation of single frames at a frame rate of 120 fps (frames per second), and there are limits on improving the frame rate by reprojection. In addition, there are also cases where there is no desire to apply reprojection uniformly to a menu or a dialog box for which a display position is fixed to the screen.

In order to display, on a head-mounted display, an image that has been subjected to reprojection processing, it is necessary to perform distortion processing for transforming the image in alignment with distortion arising in an optical system of the head-mounted display. However, when reprojection is performed on a rendered image and distortion processing is also performed thereon, deterioration of image quality due to conversion of the image cannot be avoided.

The present invention is made in light of these problems, and the purpose of the present invention is to provide an image display apparatus, an image display system, and an image display method that can suppress discomfort due to an image conversion. In addition, another purpose is to provide an image display apparatus, an image display system, and an image display method that can suppress deterioration of image quality due to an image conversion.

### Solution to Problems

In order to solve problems described above, an image display apparatus according to an aspect of the present invention includes a reprojection unit that executes reprojection processing for converting an image including depth value information to align with a viewpoint position or a line of sight direction according to a plurality of different depth values, and generates an image that has been subjected to the reprojection processing according to the plurality of different depth values.

Another aspect of the present invention is also an image display apparatus. This apparatus includes a reprojection unit that executes reprojection processing for converting a UV texture storing UV coordinate values used for sampling an image including depth value information, to align with a viewpoint position or a line of sight direction according to a plurality of different depth values, and generates a plurality of UV textures that have been subjected to the reprojection processing according to the plurality of different depth values; and a distortion processing unit that samples the image by using the plurality of UV textures that have been converted by the reprojection processing, executes distortion processing for transforming the image in alignment with distortion arising in a display optical system, and generates an image that has been subjected to the distortion processing.

Yet another aspect of the present invention is an image display system. This image display system includes an image display apparatus and an image generation apparatus. The image generation apparatus includes a rendering unit that generates a computer graphics image including depth value information by rendering an object in a virtual space, and a transmission unit that transmits the computer graphics image including the depth value information to the image display apparatus. The image display apparatus includes a reception unit that receives, from the image generation apparatus, the computer graphics image including the depth value information, and a reprojection unit that executes reprojection processing for converting the computer graphics image including the depth value information to align with a viewpoint position or a line of sight direction according to a plurality of different depth values, and generates a computer graphics image that has been subjected to the reprojection processing according to the plurality of different depth values.

Yet another aspect of the present invention is an image display method. This method includes a step of executing reprojection processing for converting an image including depth value information to align with a viewpoint position or a line of sight direction according to a plurality of different depth values; and a step of generating an image that has been subjected to the reprojection processing according to the plurality of different depth values.

In order to solve another problem described above, an image display apparatus according to an aspect of the present invention includes a reprojection unit that executes reprojection processing for converting a UV texture storing UV coordinate values used for sampling an image, to align with a viewpoint position or a line of sight direction; and a distortion processing unit that samples the image by using the UV texture that has been converted by the reprojection processing, and executes distortion processing for transforming the image in alignment with distortion arising in a display optical system.

Another aspect of the present invention is an image display system. This image display system includes an image display apparatus and an image generation apparatus. The image generation apparatus includes a rendering unit that generates a computer graphics image by rendering an object in a virtual space, and a transmission unit that transmits the computer graphics image to the image display apparatus. The image display apparatus includes a reception unit that receives the computer graphics image from the image generation apparatus, a reprojection unit that executes reprojection processing for converting a UV texture storing UV coordinate values used for sampling the computer graphics image, to align with a viewpoint position or a line of sight direction; and a distortion processing unit that samples the computer graphics image by using the UV texture that has been converted by the reprojection processing, and executes distortion processing for transforming the computer graphics image in alignment with distortion arising in a display optical system.

Yet another aspect of the present invention is an image display method. This method includes a step of executing reprojection processing for converting a UV texture storing UV coordinate values used for sampling an image, to align with a viewpoint position or a line of sight direction; and a step of sampling the image by using the UV texture that has been converted by the reprojection processing, and executing distortion processing for transforming the image in alignment with distortion arising in a display optical system.

Note that any combination of the abovementioned components or a representation of the present invention may be mutually substituted between a method, an apparatus, a system, a computer program, a data structure, a recording medium, and so forth, which are effective as an aspect of the present invention.

### Advantageous Effects of Invention

By virtue of the present invention, it is possible to suppress discomfort due to an image conversion. In addition, it is possible to suppress deterioration of image quality due to the image conversion.

### BRIEF DESCRIPTION OF DRAWINGS

FIG. 1 is an external view of a head-mounted display.

FIG. 2 is a view of a configuration of an image generation system.

FIG. 3 is a diagram illustrating a functional configuration of the head-mounted display.

FIG. 4 is a diagram illustrating a functional configuration of an image generation apparatus.

FIG. 5 is a view for describing a configuration of the image generation system.

FIG. 6 is a view for describing a procedure of asynchronous reprojection processing.

FIG. 7(a) is a view for describing reprojection processing and distortion processing according to a conventional method, and FIG. 7(b) is a view for describing reprojection processing and distortion processing according to a method of a present embodiment.

FIG. 8 is a view for describing depth reprojection processing and distortion processing.

FIG. 9 is a view for describing depth UV reprojection processing and distortion processing.

### DESCRIPTION OF EMBODIMENT

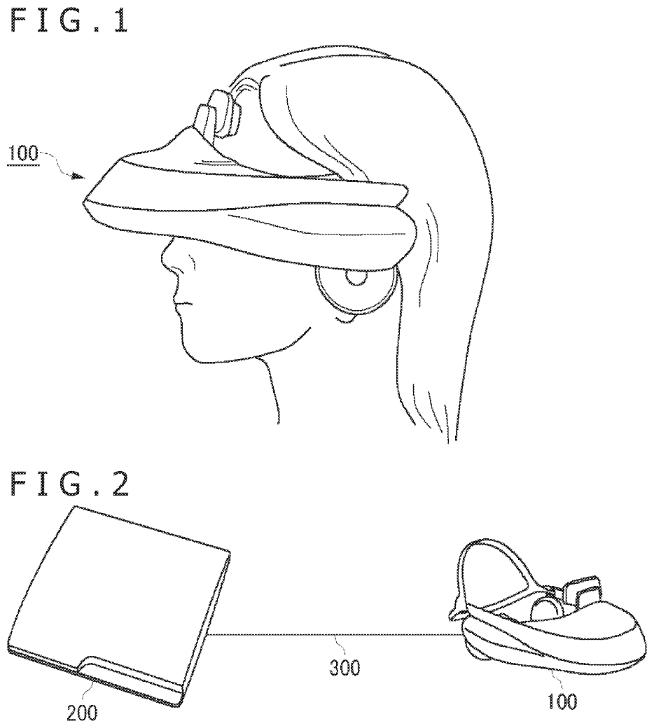

FIG. 1 is an external view of a head-mounted display 100. The head-mounted display 100 is an image display apparatus that is mounted to the head of a user and is used for appreciation of a still image, a moving image, or the like displayed by the display and for hearing audio, music, or the like outputted from headphones.

By using a gyro sensor, an acceleration sensor, or the like incorporated in or externally attached to the head-mounted display 100, it is possible to measure position information of the head of the user who wears the head-mounted display 100 and orientation information such as an angle of rotation or inclination of the head.

The head-mounted display 100 is equipped with a camera unit and can capture the outside world while the user is mounted with the head-mounted display 100.

The head-mounted display 100 is an example of a “wearable display.” Here, description is given for a method of generating an image displayed by the head-mounted display 100, but an image generation method of a present embodiment is not limited to the narrow sense of the head-mounted display 100 and can also be applied to a case where glasses, a glasses-type display, a glasses-type camera, headphones, a headset (headphones with microphone attached thereto), earphones, earrings, an ear-worn camera, a hat, a hat with camera attached thereto, a hair band, or the like is mounted.

FIG. 2 is a view of a configuration of an image generation system according to the present embodiment. The head-mounted display 100 is, for example, connected to an image generation apparatus 200 by an interface 300 which is, for example, an HDMI (registered trademark) (High-Definition Multimedia Interface). The HDMI is a standard for communication interfaces that transfers video and audio by a digital signal.

From current position/orientation information of the head-mounted display 100, the image generation apparatus 200 predicts the position/orientation information of the head-mounted display 100 in consideration of delay from generation of an image to display of the image, draws an image that is to be displayed on the head-mounted display 100, on the basis of the predicted position/orientation information of the head-mounted display 100, and transfers the drawn image to the head-mounted display 100.

A game device is an example of the image generation apparatus 200. The image generation apparatus 200 may also be connected to a server via a network. In this case, the server may provide the image generation apparatus 200 with an online application such as a game in which a plurality of users can participate via the network. The head-mounted display 100 may be connected to a computer or a portable terminal in place of the image generation apparatus 200.

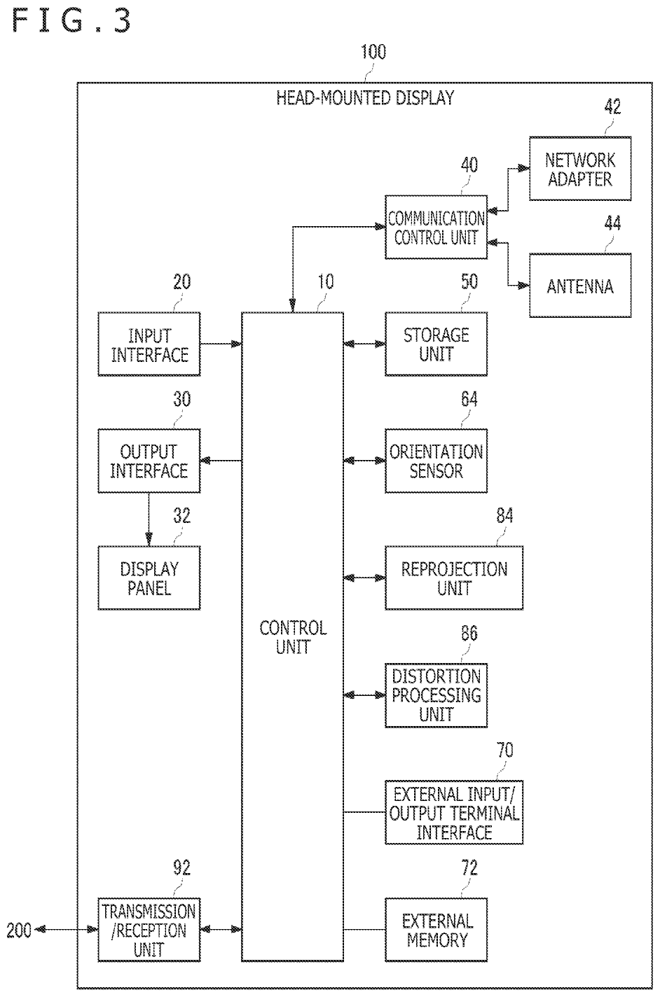

FIG. 3 is a diagram illustrating a functional configuration of the head-mounted display 100 according to the present embodiment.

A control unit 10 is a main processor that processes and outputs a signal such as an image signal or a sensor signal, a command, or data. An input interface 20 accepts an operation signal or a setting signal from a user and supplies the operation signal or the setting signal to the control unit 10. An output interface 30 receives an image signal from the control unit 10 and causes a display panel 32 to display an image.

A communication control unit 40 externally transmits data inputted from the control unit 10, by wired or wireless communication via a network adapter 42 or an antenna 44. The communication control unit 40 also receives data from an external unit by wired or wireless communication via the network adapter 42 or the antenna 44 and outputs the data to the control unit 10.

A storage unit 50 temporarily stores data, a parameter, an operation signal, or the like which is to be processed by the control unit 10.

An orientation sensor 64 detects position information of the head-mounted display 100 and orientation information such as the angle of rotation or inclination of the head-mounted display 100. The orientation sensor 64 is fabricated by appropriately combining a gyro sensor, an acceleration sensor, an angular acceleration sensor, or the like. A motion sensor obtained by combining at least one of a three-axis geomagnetic sensor, a three-axis acceleration sensor, and a three-axis gyro (angular velocity) sensor may be used to detect forward, backward, left, right, upward, and downward motions of the user's head.

An external input/output terminal interface 70 is an interface for connection of a peripheral device such as a USB (Universal Serial Bus) controller. An external memory 72 is an external memory such as a flash memory.

A transmission/reception unit 92 receives, from the image generation apparatus 200, an image generated by the image generation apparatus 200 and supplies the image to the control unit 10.

On the basis of the latest position/orientation information of the head-mounted display 100 that is detected by the orientation sensor 64, a reprojection unit 84 performs reprojection processing on a UV texture which stores UV coordinate values for sampling an image, and performs a conversion to a UV texture according to the latest viewpoint position and line of sight direction of the head-mounted display 100.

When the converted UV texture is used to refer to an image, the same effect as an effect produced when reprojection is performed on the image can be obtained, but there are differences in the degree of deterioration of the image quality. When an image is directly sampled, the image deteriorates due to interpolation processing such as bilinear interpolation between adjacent pixel values cannot be avoided. In contrast to this, because a UV texture is a texture in which UV values that change linearly are lined up, even if the bilinear interpolation is performed between adjacent UV values, the linearity of an obtained UV value is not lost, which differs to the case with pixel values. Reprojection of a UV texture has an advantage in that a non-linear conversion of pixel values by the bilinear interpolation as in the reprojection of an image does not occur. However, because there are constraints on resolution even for a texture that saves UV values, a UV value obtained by the bilinear interpolation of a UV texture differs from a true UV value, and a certain level of rounding error occurs. Accordingly, it is possible to reduce quantization error by making the resolution of a texture in which UV values are saved be larger than that of an image to reduce error due to interpolation at the time of sampling, or by saving a UV value in a texture with a long bit length such as 32 bits for one color. By increasing the resolution or precision of a UV texture in this manner, it is possible to suppress deterioration of the image.

A distortion processing unit 86 samples an image by referring to a UV texture that has been subjected to reprojection processing, performs processing on the sampled image to transform and distort the image in alignment with distortion arising in the optical system of the head-mounted display 100, and supplies the control unit 10 with the image that has been subjected to distortion processing.

The head-mounted display 100 has a configuration in which an optical lens with a high curvature is employed in order to cause a video with a high viewing angle to be displayed before and around the eyes of the user, and the user looks at a display panel via the lens. When a lens with high curvature is used, the video distorts due to distortion aberration of the lens. Accordingly, in order to appear correctly when the lens with high curvature is looked through, distortion processing is performed in advance on a rendered image, and the image that has been subjected to distortion processing is transferred to the head-mounted display and displayed on the display panel. Thus, this image that has been subjected to distortion processing appears normal when the user looks through the lens with high curvature.

The control unit 10 can supply an image or text data to the output interface 30 to cause the display panel 32 to display the image or the text data, or can supply the image or the text data to the communication control unit 40 to cause transmission externally.

Current position/orientation information of the head-mounted display 100 detected by the orientation sensor 64 is notified to the image generation apparatus 200 via the communication control unit 40 or the external input/output terminal interface 70. Alternatively, the transmission/reception unit 92 may transmit current position/orientation information of the head-mounted display 100 to the image generation apparatus 200.

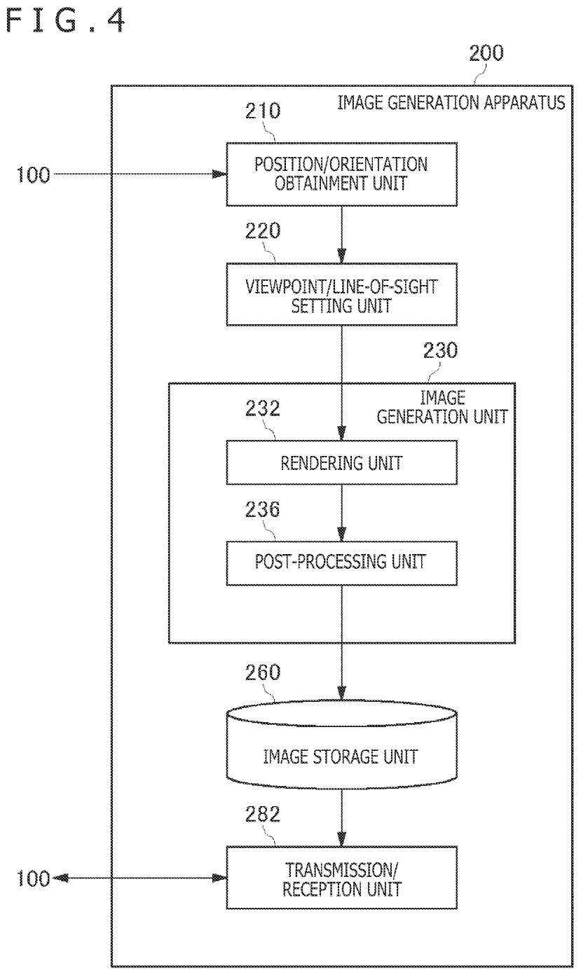

FIG. 4 is a diagram illustrating a functional configuration of the image generation apparatus 200 according to the present embodiment. FIG. 4 depicts a block diagram that focuses on functions, and these functional blocks can be implemented in many forms by only hardware, only software, or a combination of hardware and software.

At least some of the functions of the image generation apparatus 200 may be installed in the head-mounted display 100. Alternatively, at least some of the functions of the image generation apparatus 200 may be installed in a server that is connected to the image generation apparatus 200 via the network.

A position/orientation obtainment unit 210 obtains current position/orientation information of the head-mounted display 100 from the head-mounted display 100.

A viewpoint/line-of-sight setting unit 220 uses the position/orientation information of the head-mounted display 100 obtained by the position/orientation obtainment unit 210, to set a viewpoint position and a line of sight direction of the user.

An image generation unit 230 reads out data necessary for CG (Computer Graphics) from an image storage unit 260, generates a CG image by rendering an object in a virtual space, performs post-processing, and outputs the generated CG to the image storage unit 260.

The image generation unit 230 includes a rendering unit 232 and a post-processing unit 236.

According to the viewpoint position and the line of sight direction of the user that are set by the viewpoint/line-of-sight setting unit 220, the rendering unit 232 generates the CG image by rendering an object in the virtual space that can be seen in the line of sight direction from the viewpoint position of the user who wears the head-mounted display 100, and supplies the CG image to the post-processing unit 236.

The post-processing unit 236 performs post-processing such as depth of field adjustment, tone mapping, or antialiasing on the CG image, performs post-processing such that the CG image appears smooth and natural, and stores the CG image in the image storage unit 260.

A transmission/reception unit 282 reads out, from the image storage unit 260, frame data of the CG image generated by the image generation unit 230 and transfers the frame data to the head-mounted display 100. The transmission/reception unit 282 may read out frame data of the CG image which includes alpha values and depth information, and may transfer the frame data to the head-mounted display 100 as a RGBAD image via a communication interface that can transfer an RGBAD image signal. Here, the RGBAD image signal is an image signal resulting from adding an alpha value and a depth value to the value of each color among red, green, and blue, for each pixel.

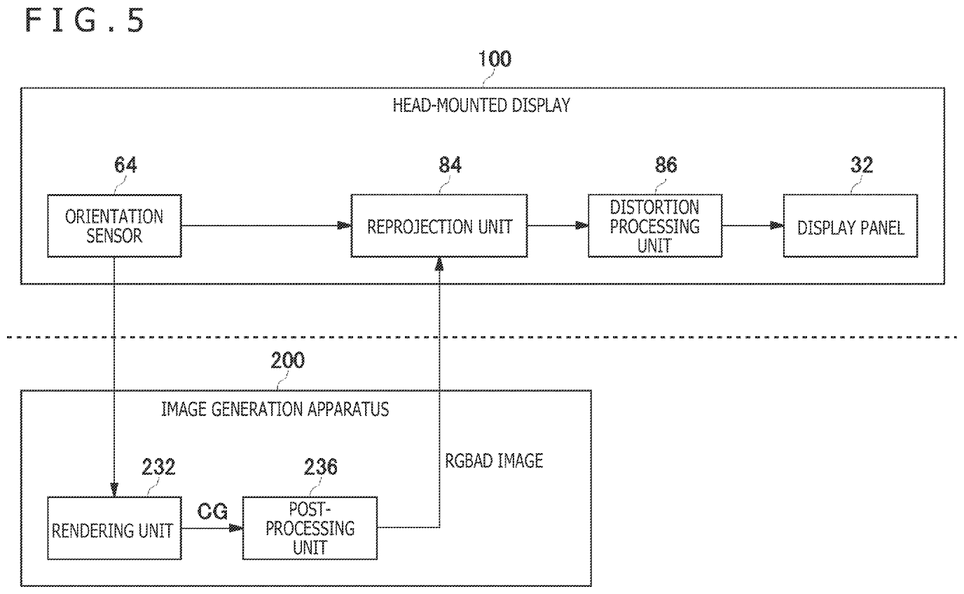

FIG. 5 is a view for describing a configuration of the image generation system according to the present embodiment. Here, in order to simplify the description, the main configurations of the head-mounted display 100 and the image generation apparatus 200 for generating and displaying a CG image are illustrated and described.

The viewpoint position and the line of sight direction of the user that are detected by the orientation sensor 64 of the head-mounted display 100 is transmitted to the image generation apparatus 200 and supplied to the rendering unit 232.

The rendering unit 232 of the image generation apparatus 200 generates a virtual object seen from the viewpoint position and the line of sight direction of the user who wears the head-mounted display 100, and supplies a CG image to the post-processing unit 236.

The post-processing unit 236 performs post-processing on the CG image, transmits a result of the post-processing as an RGBAD image that includes alpha values and depth information to the head-mounted display 100, and the RGBAD image is supplied to the reprojection unit 84.

The reprojection unit 84 of the head-mounted display 100 obtains the latest viewpoint position and line of sight direction of the user that are detected by the orientation sensor 64, converts a UV texture which stores UV coordinate values for sampling the CG image so as to align with the latest viewpoint position and line of sight direction, and supplies the converted UV texture to the distortion processing unit 86.

The distortion processing unit 86 samples the CG image by referring to the UV texture to which the reprojection processing has been performed, and performs distortion processing on the sampled CG image. The CG image to which the distortion processing has been performed is displayed on the display panel 32.

In the present embodiment, description is given for a case where the reprojection unit 84 and the distortion processing unit 86 are provided in the head-mounted display 100, but the reprojection unit 84 and the distortion processing unit 86 may be provided in the image generation apparatus 200. The reprojection unit 84 and the distortion processing unit 86 being provided in the head-mounted display 100 is advantageous in that the latest orientation information detected by the orientation sensor 64 can be used on a real time basis. However, in a case where there are constraints on the processing ability of the head-mounted display 100, it is possible to employ a configuration in which the reprojection unit 84 and the distortion processing unit 86 are provided in the image generation apparatus 200. In this case, the latest orientation information detected by the orientation sensor 64 is received from the head-mounted display 100, the reprojection processing and the distortion processing are performed in the image generation apparatus 200, and an image resulting from this processing is transmitted to the head-mounted display 100.

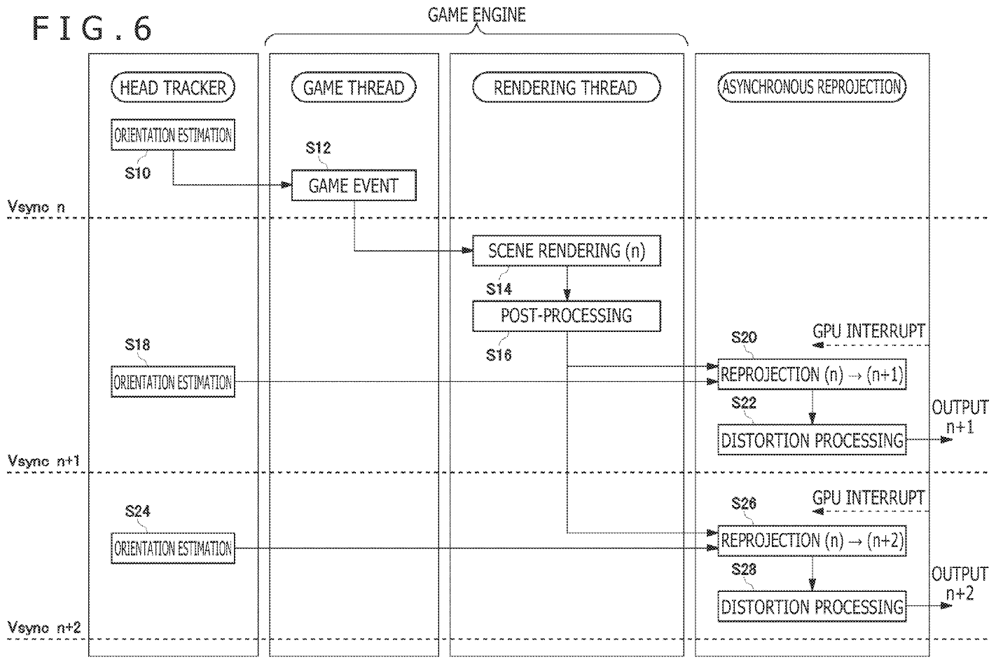

FIG. 6 is a view for describing a procedure of asynchronous reprojection processing of the present embodiment.

A head tracker that includes, for example, the orientation sensor 64 of the head-mounted display 100 estimates the orientation of the user wearing the head-mounted display at a timing of an nth VSYNC (Vertical Sync Signal) (S10).

A game engine executes a game thread and a rendering thread. The game thread causes a game event to occur at the timing of the nth VSYNC (S12). The rendering thread executes scene rendering on the basis of the orientation estimated at the timing of the nth VSYNC (S14), and performs post-processing on a rendered image (S16). Because scene rendering typically takes time, there is a need to perform reprojection on the basis of the latest orientation before the next scene rendering is executed.

Reprojection is performed asynchronously with respect to the rendering performed by the rendering thread, at a timing of a GPU interrupt. The head tracker estimates the orientation at the timing of the (n+1)th VSYNC (S18). On the basis of the orientation estimated at the timing of the (n+1)th VSYNC, reprojection processing is performed on a UV texture for referring to the image rendered at the timing of the nth VSYNC, and the UV texture for the timing of the nth VSYNC is converted to a UV texture for the timing of the (n+1)th VSYNC (S20). Referring to the reprojected UV texture, the image rendered at the timing of the nth VSYNC is sampled, and distortion processing is executed (S22). Then, the distorted image for the timing of the (n+1)th VSYNC is outputted.

Similarly, the head tracker estimates the orientation at the timing of the (n+2)th VSYNC (S24). On the basis of the orientation estimated at the timing of the (n+2)th VSYNC, reprojection processing is performed on a UV texture for referring to the image rendered at the timing of the nth VSYNC, and the UV texture for the timing of the nth VSYNC is converted to a UV texture for the timing of the (n+2)th VSYNC (S26). Referring to the reprojected UV texture, the image rendered at the timing of the nth VSYNC is sampled, and distortion processing is executed (S28). Then, the distorted image for the timing of the (n+2)th VSYNC is outputted.

Note that, although description is given of a case of performing asynchronous reprojection two times before the next scene rendering is executed, the number of times asynchronous reprojection is performed changes according to the amount of time needed for scene rendering.

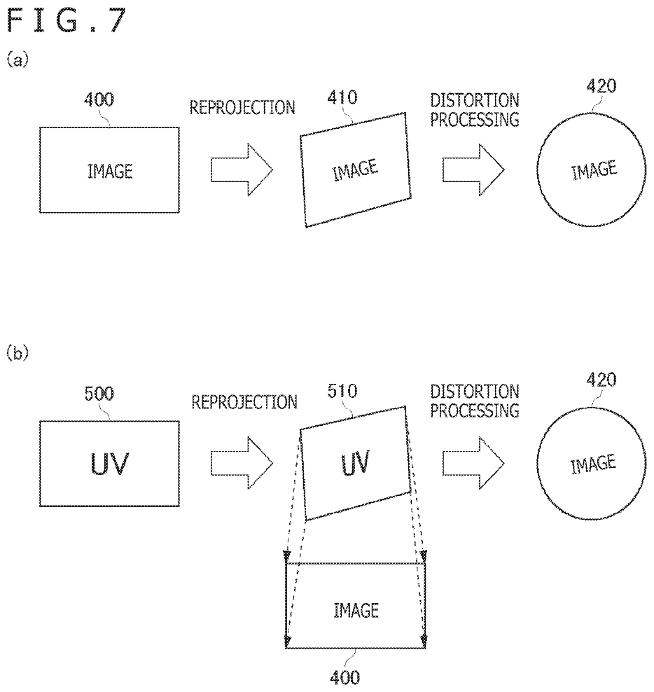

With reference to FIG. 7(a) and FIG. 7(b), description is given by comparing reprojection processing and distortion processing according to a conventional method and reprojection processing and distortion processing according to the method of the present embodiment.

In a GPU that has a programmable shader function, a vertex shader processes attribute information regarding polygon vertexes, and a pixel shader processes an image in units of pixels.

FIG. 7(a) illustrates the reprojection processing and the distortion processing according to the conventional method. In a first pass for rendering, the vertex shader performs reprojection processing on an image 400 and generates an image 410 that has been subjected to the reprojection processing. Next, in a second pass, the pixel shader performs distortion processing on the image 410 that has been subjected to reprojection processing, and generates an image 420 that has been subjected to distortion processing. The distortion processing includes chromatic aberration correction for each color of R, G, and B.

In the conventional method of FIG. 7(a), in the first pass, when the vertex shader performs reprojection processing, the vertex shader samples pixels from the image 400 and generates the image 410 which has been subjected to reprojection by the bilinear interpolation or the like. Next, in the second pass, when the pixel shader performs distortion processing, the pixel shader samples pixels from the image 410 which has been subjected to reprojection, and generates the image 420 which has been subjected to the distortion processing by the bilinear interpolation or the like. In other words, because sampling and interpolation of pixels are performed twice in the first pass and the second pass, deterioration of image quality cannot be avoided.

Note that here, in a case where the reprojection processing is performed by the vertex shader, distortion processing cannot be performed by the pixel shader in the same rendering pass. This is because the pixel shader cannot sample other pixels that are generated in the same pass. Accordingly, the processing is divided into two passes: the first pass and the second pass. In the first pass, the vertex shader performs reprojection and temporarily writes, to memory, the image that has been subjected to reprojection processing. In the second pass, the pixel shader performs distortion processing on the image that has been subjected to reprojection processing. In this case, it is not possible to avoid deterioration of image quality due to pixel sampling being performed twice.

If, hypothetically, the reprojection processing and the distortion processing were performed in one pass, only the vertex shader would execute reprojection processing and distortion processing, but even if screen coordinates that differed among each color of R, G, and B were calculated by the vertex shader, only one set of screen coordinates could be handled in rasterize processing. Therefore, it is not possible for the vertex shader to calculate distortion that differs for each color of R, G, and B, for each pixel in one occasion. In other words, in order to perform a chromatic aberration correction for each color of R, G, and B by the vertex shader and the pixel shader, there is no choice other than the pixel shader performing chromatic aberration correction for each color of R, G, and B in the second pass, with the number of times sampling is performed being two times.

FIG. 7(b) illustrates the reprojection processing and the distortion processing according to the method of the present embodiment. In a first pass, the vertex shader performs reprojection processing on a UV texture 500 that stores UV coordinate values for sampling an image, and generates a UV texture 510 that has been subjected to reprojection. Next, in the second pass, the pixel shader refers to the UV texture 510 that has been subjected to reprojection, to sample the image 400, and generates the image 420 that has been subjected to distortion processing by the bilinear interpolation or the like.

With the present method, instead of reprojection being performed on an image, reprojection (referred to as “UV reprojection”) is performed on a UV texture which is a texture reference source used when performing a texture mapping of the image. In UV reprojection, sampling of the image is not performed at a time of reprojection of the UV texture. Because sampling and interpolation of the image are only performed once when distortion processing is performed in the second pass, there is less deterioration of image quality than that in the conventional method.

In addition, when performing reprojection processing on a UV texture in the first pass, because sufficient approximate solutions can be obtained by linear interpolation in a case of a low angle of reprojection, the size of the UV texture may be small. There may be a lower memory capacity and power consumption necessary for memory access can also be suppressed, in comparison to a case where reprojection is directly performed on an image as in the conventional method and the converted image is stored in memory.

In this manner, by virtue of UV reprojection according to the present method, at the time of reprojection, an image is not directly sampled, and the original image before transformation is referred to on the basis of the UV texture that has been transformed by the reprojection. Thus, deterioration of image quality does not arise at a time of reprojection.

Next, description is given regarding a case of performing reprojection on an image including depth value (depth) information such that there is alignment to a viewpoint position or a line of sight direction according to a plurality of different depth values (referred to as “depth reprojection”).

In depth reprojection, the reprojection unit 84 executes reprojection processing for converting an image such that there is alignment to a viewpoint position or a line of sight direction according to a plurality of different depths, and generates a composite image by compositing a plurality of images subjected to reprojection processing according to the plurality of different depths. The distortion processing unit 86 performs distortion processing on the composite image.

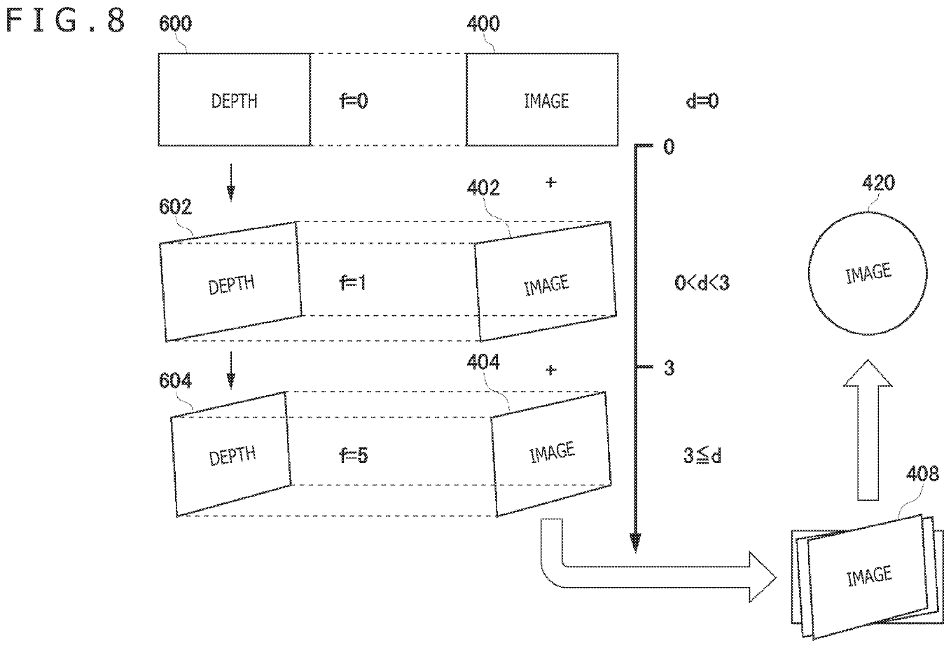

FIG. 8 is a view for describing depth reprojection processing and distortion processing.

The depth value of each pixel of the image 400 is stored in a depth buffer. Here, as an example, three representative depths are set with f=0, 1, and 5 (meters are used as an example of a unit), and the range of depths for the image are divided into three stages, that is, d=0, 0<d<3, and 3≤d. The lower the depth in a region of an image is, the more this region is displaced by reprojection processing.

The reprojection unit 84 does not perform reprojection on the image of a region where the value d of the depth 600 is 0. For the region where the value d of the depth 600 is 0, the original image 400 is used unchanged. A region where the value of the depth 600 is 0 is, for example, a menu, a dialog box, or the like that is displayed at the front of the virtual space. A region where the value d of the depth 600 is 0 is not subject to reprojection processing, and is thus not impacted by reprojection processing and does not move on the screen.

Regarding a region where the value d of the depth 600 is not 0 and the value d of a depth 602 that has been subjected to reprojection processing in which f=1 is in the range of 0<d<3, the reprojection unit 84 generates an image 402 that has been subjected to reprojection processing in which f=1.

Regarding a region where the value d of the depth 600 is not 0 and the value d of the depth 602 that has been subjected to reprojection processing in which f=1 is in the range of 3≤d, the reprojection unit 84 generates an image 404 that has been subjected to reprojection processing in which f=5.

In the above description, an image that has been subjected to reprojection processing is generated by performing reprojection processing on an image for each representative depth and compositing a plurality of images that have been subjected to reprojection processing for respective representative depths. As another method, an image that has been subjected to reprojection processing may be generated by causing a three-dimensional transformation in which the pixels of the image are set as a point cloud, generating a simple mesh from the depth buffer, and performing three-dimensional rendering.

The distortion processing unit 86 performs distortion processing on a composite image 408, and generates the image 420 that has been subjected to the distortion processing.

By dividing the depth range of an image into a plurality of depth ranges according to a plurality of representative depths, performing reprojection processing on each representative depth, and compositing a plurality of images that have been subjected to the reprojection processing for respective representative depths, it is possible to generate a more natural image with less discomfort than the case where reprojection is performed uniformly on the entirety of an image without considering depth. As a result, it is possible to prevent an unnatural motion from occurring even if the frame rate of an image is increased due to the reprojection.

How the representative depths are set is defined as desired. There may be division to three or more representative depths. If there is no region in which it is not preferable to perform reprojection, such as a fixed position menu, a case where the depth is zero does not need to be set. In addition, the values or number of representative depths may be dynamically changed according to a distribution of depth in a rendered image. A valley of the depth distribution may be detected on the basis of a histogram of depths included in the image, and the values and number of representative depths may be determined such that the range of depths is divided at the valley of the depth distribution.

In the above description, reprojection is performed on an image according to a plurality of different depths, but a technique of UV reprojection may be applied here. The reprojection unit 84 executes reprojection processing on a UV texture according to the plurality of different depths, and generates a plurality of UV textures that have been subjected to reprojection processing according to the plurality of different depths. The distortion processing unit 86 uses the plurality of UV textures that have been converted by the reprojection processing, to sample the image and execute distortion processing, and generates an image that has been subjected to distortion processing. This is referred to as “depth UV reprojection.”

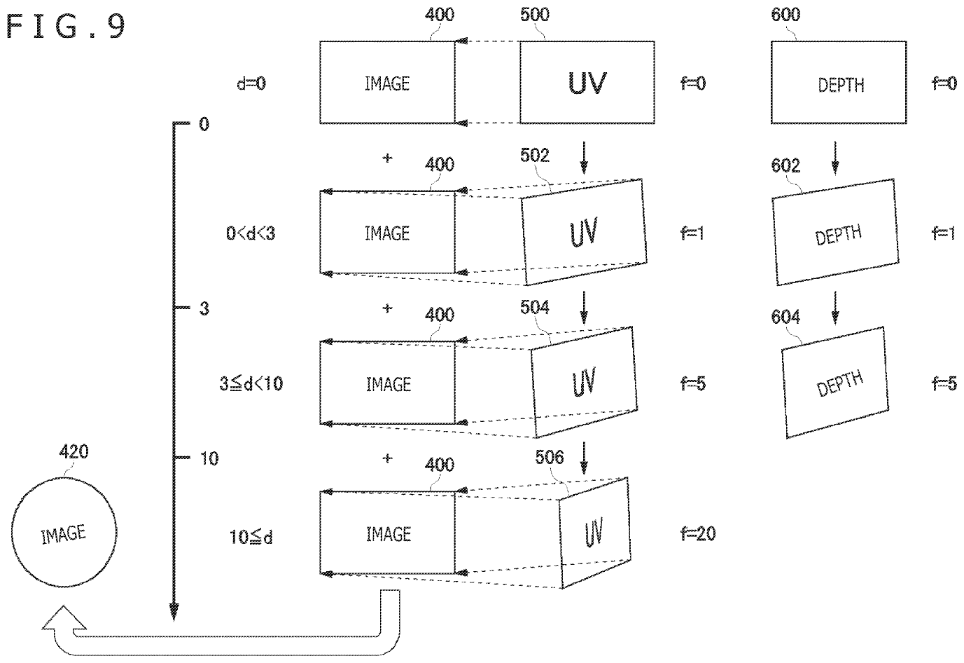

FIG. 9 is a view for describing depth UV reprojection processing and distortion processing.

By using UV reprojection, it is possible to generate a reprojection image with low discomfort by reprojection based on depth while deterioration in image quality due to sampling is avoided.

Regarding depth, three representative depths are set with f=0, 1, and 5, the range of depth of an image is divided into three stages, that is, d=0, 0<d<3, and 3≤d, and reprojection is performed to the depth for each representative depth. Regarding the UV texture, four representative depths are set with f=0, 1, 5, and 20, the range of depth of an image is divided into four stages, that is, d=0, 0<d<3, 3≤d<10, and 10≤d, and reprojection is performed on the UV texture for each representative depth.

The reprojection unit 84 does not perform reprojection on the image of a region where the value d of the depth 600 is 0. Regarding a region where the value d of the depth 600 is 0, the UV texture 500 is used unchanged to sample the image 400.

With respect to a region where the value d of the depth 600 is not 0 and the value d of the depth 602 that has been subjected to reprojection processing in which f=1 satisfies 0<d<3, the reprojection unit 84 uses a UV texture 502 to sample the image 400.

With respect to a region where the value d of the depth 600 is not 0, the value d of the depth 602 that has been subjected to reprojection processing in which f=1 is 3≤d, and the value d of a depth 504 that has been subjected to reprojection processing in which f=5 satisfies 3≤d<10, the reprojection unit 84 uses a UV texture 504 to sample the image 400.

With respect to a region where the value d of the depth 600 is not 0, the value d of the depth 602 that has been subjected to reprojection processing in which f=1 is 3≤d, and the value d of a depth 604 that has been subjected to reprojection processing in which f=5 is 10≤d, the reprojection unit 84 uses a UV texture 506 to sample the image 400.

Because a user is not very sensitive in regard to error in the depth direction of an image, the impact on image quality is small even if the number of representative depths is made to be small for depth reprojection.

While reprojection is performed with respect to each of depth and UV textures in the description of FIG. 9, a texture (U, V, D) obtained by combining UV and depth (referred to as a “UVD texture”) may be generated, and reprojection may be performed on the UVD texture. For example, in an image buffer for storing the three colors of R, G, and B, in a case where a U value is stored in R (red), where a V value is stored in G (green), and where a depth value is stored in B (blue), it is possible to store a UVD texture in an RGB image buffer. The efficiency is better than the case of separately performing reprojection with respect to depth and a UV texture.

Next, description is given for a method of dealing with an occlusion region that occurs due to a depth reprojection. In ordinary reprojection that does not consider depth (in which depth is fixed), because the entirety of the image is transformed, the problem of occlusion does not occur. However, when depth reprojection is performed, the amount of displacement differs according to depth, and the more that an object is in front, the more the object moves. Therefore, typically, when an object in front moves, a region that has not been seen before appears as an occlusion region. Because an occlusion region cannot be drawn, if the occlusion region is unchanged, the occlusion region is filled in with black or the like and becomes unnatural.

Accordingly, so as not to be unnatural even if an occlusion region occurs, a past frame (for example, one frame earlier) is used as an initial value, and an image that has been subjected to reprojection according depth through a depth reprojection is overwritten on the past frame. As a result, even in a case where an occlusion region occurs due to a depth reprojection, the past frame is drawn as an initial value for the occlusion region, and thus, it is possible to avoid unnaturalness.

In place of a past frame, a reprojected past frame obtained by performing ordinary reprojection with a fixed depth on the past frame may be used as the initial value before the depth reprojection. Because the past frame itself aligns with the past viewpoint position or line of sight direction, by using a frame that has been aligned with the current viewpoint position or line of sight direction by the ordinary reprojection with fixed depth, a more natural image can be obtained. Note that, in the case of performing the ordinary reprojection with fixed depth, an occlusion region does not occur unlike the depth reprojection, and thus, there is no problem even if it is used as the initial value.

Next, description is given regarding additive reprojection. An image based on past depth reprojection is subjected to reprojection to align with the current viewpoint position or line of sight direction, and the resultant image is added to an image based on current depth reprojection. Thus, it is possible to increase the resolution of the image. Here, other than simply adding together a plurality of frames, a weighted sum, an average, or a median of the plurality of frames may be obtained. The additive reprojection is more effective when used with ray tracing. Rendering by ray tracing takes time and thus has a lower frame rate, but it is possible to improve resolution in the time direction as well as the space direction by reprojecting and adding together past rendering results. By performing the additive reprojection, besides improving resolution, effects such as reducing noise or aliasing or achieving a HDR (High Dynamic Range) for an image by improving color depth can be achieved.

Description has been given on the basis of the embodiment of the present invention. The embodiment is an example, and it is understood by a person skilled in the art that various modifications can be made to combinations of respective components or processing processes of the embodiment, and that these modifications are within the scope of the present invention.

In the embodiment described above, description has been given for distortion processing premised on the case where non-linear distortion occurs in a display image as with the optical system of the head-mounted display 100, but there is no limitation to non-linear distortion, and the present embodiment can be employed even in the case of linear distortion. For example, the present embodiment can be employed even in a case where at least a portion of a displayed image is scaled. In a case of projecting an image by a projector onto a wall or the like, the projector is installed diagonally so as to be pointed up at the wall, and thus, there is a need to perform a trapezoidal transformation on the image in advance. The present embodiment can be employed even in a case of performing such linear distortion on an image.

In the embodiment described above, description has been given for a case of performing reprojection in alignment with the viewpoint of the head-mounted display 100. Even in a case of usage other than for a head-mounted display, such as displaying on a television monitor, in order to increase the frame rate after performing reprojection to align with the viewpoint of a camera, it is possible to use the UV reprojection, the depth reprojection, and the depth UV reprojection according to the present embodiment.

### INDUSTRIAL APPLICABILITY

This invention can be used in image display technology.

### REFERENCE SIGNS LIST

10: Control unit
20: Input interface
30: Output interface
32: Display panel
40: Communication control unit
42: Network adapter
44: Antenna
50: Storage unit
64: Orientation sensor
70: External input/output terminal interface
72: External memory
84: Reprojection unit
86: Distortion processing unit
92: Transmission/reception unit
100: Head-mounted display
200: Image generation apparatus
210: Position/orientation obtainment unit
220: Viewpoint/line-of-sight setting unit
230: Image generation unit
232: Rendering unit
236: Post-processing unit
260: Image storage unit
282: Transmission/reception unit
300: Interface

1. An image display apparatus comprising:
a reprojection unit that executes reprojection processing for converting an image including depth value information to align with a viewpoint position or a line of sight direction according to a plurality of different depth values, and generates an image that has been subjected to the reprojection processing according to the plurality of different depth values.

2. The image display apparatus according to claim 1, wherein the reprojection unit generates a composite image by compositing a plurality of images that have been subjected to the reprojection processing according to the plurality of different depth values.

3. The image display apparatus according to claim 1, wherein
the reprojection unit does not perform the reprojection processing on a region in which a depth value is a predetermined value.

4. The image display apparatus according to claim 1, wherein the plurality of different depth values are determined on a basis of a distribution of depth values included in the image.

5. The image display apparatus according to claim 1, wherein the reprojection unit generates the image that has been subjected to the reprojection processing by setting a result of drawing of a frame of a past image as an initial value and overwriting the initial value.

6. The image display apparatus according to claim 1, wherein the reprojection unit generates the image that has been subjected to the reprojection processing by setting, as an initial value, an image obtained by executing the reprojection processing for converting a frame of a past image to align with the viewpoint position or the line of sight direction without division into the plurality of different depth values, and overwriting the initial value.

7. The image display apparatus according to claim 1, wherein the reprojection unit obtains a sum, an average, and a median between a past image that has been converted to align with a current viewpoint position or a current line of sight direction and the image that has been subjected to the reprojection processing.

8. An image display apparatus comprising:
a reprojection unit that executes reprojection processing for converting a UV texture storing UV coordinate values used for sampling an image including depth value information, to align with a viewpoint position or a line of sight direction according to a plurality of different depth values, and generates a plurality of UV textures that have been subjected to the reprojection processing according to the plurality of different depth values; and
a distortion processing unit that samples the image by using the plurality of UV textures that have been converted by the reprojection processing, executes distortion processing for transforming the image in alignment with distortion arising in a display optical system, and generates an image that has been subjected to the distortion processing.

9. An image display system comprising:
an image display apparatus; and
an image generation apparatus, wherein
the image generation apparatus includes
a rendering unit that generates a computer graphics image including depth value information by rendering an object in a virtual space, and
a transmission unit that transmits the computer graphics image including the depth value information to the image display apparatus, and
the image display apparatus includes
a reception unit that receives, from the image generation apparatus, the computer graphics image including the depth value information, and
a reprojection unit that executes reprojection processing for converting the computer graphics image including the depth value information to align with a viewpoint position or a line of sight direction according to a plurality of different depth values, and generates a computer graphics image that has been subjected to the reprojection processing according to the plurality of different depth values.

10. The image display system according to claim 9, wherein the reprojection processing by the image display apparatus is performed asynchronously with respect to rendering by the image generation apparatus.

11. An image display method comprising:
executing reprojection processing for converting an image including depth value information to align with a viewpoint position or a line of sight direction according to a plurality of different depth values; and
generating an image that has been subjected to the reprojection processing according to the plurality of different depth values.

12. A non-transitory, computer readable storage medium containing a program, which when executed by a computer, causes the computer to perform an image display method by carrying out actions, comprising:
executing reprojection processing for converting an image including depth value information to align with a viewpoint position or a line of sight direction according to a plurality of different depth values; and
generating an image that has been subjected to the reprojection processing according to the plurality of different depth values.

13. An image display apparatus comprising:
a reprojection unit that executes reprojection processing for converting a UV texture storing UV coordinate values used for sampling an image, to align with a viewpoint position or a line of sight direction; and
a distortion processing unit that samples the image by using the UV texture that has been converted by the reprojection processing, and executes distortion processing for transforming the image in alignment with distortion arising in a display optical system.

14. The image display apparatus according to claim 13, wherein sampling of the image is not performed in the conversion of the UV texture by the reprojection unit.

15. The image display apparatus according to claim 13, wherein the distortion processing includes chromatic aberration correction.

16. The image display apparatus according to claim 13, wherein the reprojection processing is executed in a first pass by a vertex shader, and the distortion processing is executed in a second pass by a pixel shader.

17. An image display system comprising:
an image display apparatus; and
an image generation apparatus, wherein
the image generation apparatus includes
a rendering unit that generates a computer graphics image by rendering an object in a virtual space, and
a transmission unit that transmits the computer graphics image to the image display apparatus, and
the image display apparatus includes
a reception unit that receives the computer graphics image from the image generation apparatus,
a reprojection unit that executes reprojection processing for converting a UV texture storing UV coordinate values used for sampling the computer graphics image, to align with a viewpoint position or a line of sight direction; and
a distortion processing unit that samples the computer graphics image by using the UV texture that has been converted by the reprojection processing, and executes distortion processing for transforming the computer graphics image in alignment with distortion arising in a display optical system.

18. The image display system according to claim 17, wherein the reprojection processing and the distortion processing by the image display apparatus is performed asynchronously with respect to rendering by the image generation apparatus.

19. An image display method comprising:
executing reprojection processing for converting a UV texture storing UV coordinate values used for sampling an image, to align with a viewpoint position or a line of sight direction; and
sampling the image by using the UV texture that has been converted by the reprojection processing, and executing distortion processing for transforming the image in alignment with distortion arising in a display optical system.

20. A non-transitory, computer readable storage medium containing a program, which when executed by a computer, causes the computer to perform an image display method by carrying out actions, comprising:
executing reprojection processing for converting a UV texture storing UV coordinate values used for sampling an image, to align with a viewpoint position or a line of sight direction; and
sampling the image by using the UV texture that has been converted by the reprojection processing, and executing distortion processing for transforming the image in alignment with distortion arising in a display optical system.
